(19) United States
(12) Patent Application Publication
(10) Pub. No.: US 2017/0060321 A1
(43) Pub. Date: Mar. 2, 2017

(54) TOUCH INPUT SENSING DEVICE

(71) Applicant: Samsung Electro-Mechanics Co., Ltd., Suwon-si (KR)

(72) Inventors: Moon Suk JEONG, Suwon-si (KR); Ui Jong SONG, Suwon-si (KR); Yong Il KWON, Suwon-si (KR)

(73) Assignee: Samsung Electro-Mechanics Co., Ltd., Suwon-si (KR)

(21) Appl. No.: 15/099,832

(22) Filed: Apr. 15, 2016

(30) Foreign Application Priority Data
Aug. 26, 2015 (KR) 10-2015-0119929

(51) Int. Cl. G06F 3/041; G06K 9/00; G06F 3/044

(52) U.S. Cl. CPC G06F 3/0416; G06F 3/044; G06K 9/0002; G06K 9/0008

(57) ABSTRACT

A touch input sensing device includes a sensing electrode, a driver configured to apply a driving signal to the sensing electrode, and a sensor configured to sense a touch input from the sensing electrode and to operate at a frequency higher than that of the driving signal.

### CROSS-REFERENCE TO RELATED APPLICATION(S)

This application claims the benefit of Korean Patent Application No. 10-2015-0119929 filed on Aug. 26, 2015, in the Korean Intellectual Property Office, the entire disclosure of which is incorporated herein by reference for all purposes.

### BACKGROUND

1. Field

The following description relates to a touch input sensing device.

2. Description of Related Art

A touch input sensing device is an input device generally attached to a display device in the form of a touch screen or a touch pad to provide an intuitive input method to users. Touch input sensing devices commonly serve as an input device to various electronic devices such as mobile phones, personal digital assistants (PDAs), and navigation devices.

Also, a touch input sensing device may serve as an input device for recognizing a fingerprint. Thus, a touch input sensing device for fingerprint recognition may beneficially have sensitivity higher than that of a touch screen or a touch pad.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to a general aspect, a touch input sensing device includes a sensing electrode, a driver configured to apply a driving signal to the sensing electrode, and a sensor configured to sense a touch input from the sensing electrode, and to operate at a frequency higher than that of the driving signal.

The touch input sensing device may further include a reference signal generator configured to apply a reference signal having a frequency higher than that of the driving signal to the sensing circuit, and, synchronize the driving signal and the reference signal such that a level of the reference signal is increased from a predetermined level at a point in time different from a point in time at which a level of the driving signal is increased from a predetermined level.

The reference signal generator may be further configured to generate the driving signal having a square wave, and the reference signal having a square wave and a frequency about two-fold higher than that of the driving signal.

The reference signal generator may be further configured to generate a reference signal having a level falling at a point in time when the level of the driving signal rises or falls.

The sensor may include a first switch connected to the plurality of sensing electrodes and configured to be turned on or off based on the reference signal, a second switch connected to the first switch and configured to be turned on or off based on the reference signal, a first capacitor having one end connected to the first switch, and connected to the second switch in parallel, and a first operational amplifier having an input terminal connected to the first switch, the second switch, and the first capacitor, and an output terminal connected to the second switch and the first capacitor.

The reference signal generator may be further configured to determine a time difference between a point in time at which the level of the driving signal rises from a predetermined level and a point in time at which the level of the reference signal rises from a predetermined level, on the basis of capacitance of the first capacitor.

The touch input sensing device may further include a differential integrator connected to the sensing circuit, the differential integrator may be configured to integrate an output signal from the sensing circuit, and convert the output signal to differential signal, and, receive the driving signal and operate at a frequency of the driving signal.

The sensing electrode may include a first electrode connected to the driver and configured to receive the driving signal, and a second electrode disposed to intersect with the first electrode, connected to the sensor, and configured to provide a variation in capacitance according to a touch input to the sensing circuit, wherein the sensing electrodes are configured to sense a difference in height between a ridge and a valley of a fingerprint of a contact finger and/or an interval between the ridge and the valley.

According to another general aspect, a touch input sensing device includes a sensing electrode, a driver configured to activate the sensing electrode, a sensor configured to sense a touch input from the sensing electrode, and a reference signal generator configured to apply a first clock signal to the driver and apply a second clock signal to the sensor, wherein the reference signal generator is configured to adaptively stagger the first and second clock signals to prevent a rising point of the second clock signal from matching a rising point of the first clock signal.

The reference signal generator may be configured to set a frequency of the second clock signal to be higher than that of the first clock signal by a multiple of about 2.

The reference signal generator may be configured to delay a phase of the second clock signal such that a falling point of the second clock signal matches a rising point of the first clock signal.

The sensor may includes a first switch connected to the sensing electrode and configured to be turned on or off on the basis of the second clock signal, a second switch connected to the first switch and configured to be turned on or off on the basis of the second clock signal, a first capacitor having one end connected to the first switch, and connected to the second switch in parallel, and a first operational amplifier having an input terminal connected to the first switch, and connected to the second switch and the first capacitor in parallel.

The reference signal generator may be configured to determine a time difference between a point in time at which the first clock signal rises and a point in time at which the second clock signal rises, on the basis of capacitance of the first capacitor.

The touch input sensing device may further include a differential integrator connected to the sensing circuit, the differential integrator may be configured to integrate a single output signal from the sensing circuit, convert the single output signal to a differential signal, and, receive the first clock signal and operate at a frequency of the driving signal.

The sensing electrode may include a first electrode connected to the driver, the first electrode configured to receive the first clock signal, and a second electrode disposed to intersect with the first electrode, the second electrode configured to connect to the sensor to provide a variation in capacitance according to a touch input to the sensing circuit, wherein the sensing electrodes are configured to sense a difference in height between at least one of a ridge and a valley of a fingerprint of a contact finger or an interval between the ridge and the valley.

According to another general aspect, a touch input device includes a plurality of sense electrodes, a sensor coupled to the plurality of sense electrodes, a signal generator configured to generate and apply a driving signal to the plurality of sense electrodes, and, generate and apply a reference signal to the sensor, wherein one of the reference signal and the driving signal are adaptively delayed one relative to the other, and, a differential integrator coupled to the sense electrodes, the differential integrator being configured to calculate a difference between sensed touch signals from neighboring sense electrodes.

Other features and aspects will be apparent from the following detailed description, the drawings, and the claims.

### BRIEF DESCRIPTION OF THE DRAWINGS

The above and other aspects, features and advantages of the present disclosure will be more clearly understood from the following detailed description taken in conjunction with the accompanying drawings, in which:

FIG. 1 is a diagram of a touch input sensing device according to an embodiment.

FIG. 2 is a view illustrating an example structure of a plurality of sensing electrodes of FIG. 1.

FIG. 3 is a view illustrating a touch input sensing device according to an embodiment.

FIG. 4A is a view illustrating example waveforms of first clock signals applied to the driver of FIG. 3.

FIG. 4B is a view illustrating example waveforms of a second clock signal applied to the sensor of FIG. 3.

FIG. 4C illustrates an example precedence or delay of the second clock signal.

FIG. 5 is an example circuit diagram illustrating a sensor and a differential integrator of FIG. 3.

FIG. 6 is a view illustrating example waveforms at respective nodes of FIG. 5.

FIGS. 7A and 7B are graphs illustrating an example input terminal waveform and an output terminal waveform of the driver of FIG. 3.

FIGS. 8A and 8B are graphs illustrating example waveforms of the sensor of FIG. 3 when a reference signal applied to the sensor is not delayed.

FIGS. 9A and 9B are graphs illustrating example waveforms of the sensor of FIG. 3 when a reference signal applied to the sensor is delayed.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

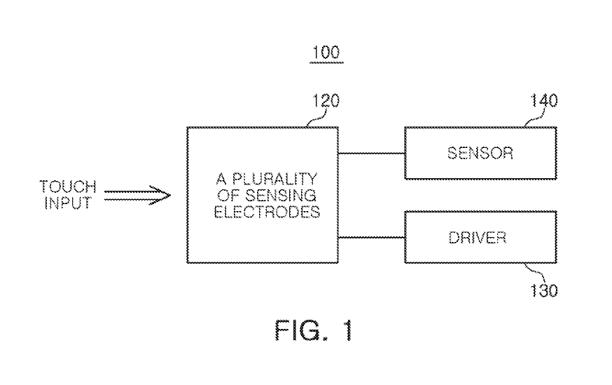

FIG. 1 is a conceptual view of a touch input sensing device according to an embodiment.

Referring to FIG. 1, the touch input sensing device 100 includes a plurality of sensing electrodes 120, a driver 130, and a sensor 140.

For example, the touch input sensing device 100 may be integrally provided in a display device and have a suitably high transmittance that light may be transmitted through a screen displayed on the display device. Thus, the touch input sensing device may be realized as a base substrate formed of a transparent film such as a polyethylene terephthalate (PET), polycarbonate (PC), polyethyersulfone (PES), or polyimide (PI). Thus, the touch input sensing device 100 may sense a touch input position on a display device.

Also, the touch input sensing device 100 may be manufactured by patterning a sensing electrode on a circuit board with a metal, rather than being integrally provided with the display device such as a touch pad of a notebook computer, or the like. Thus, the touch input sensing device 100 may is configured to have a suitable sensitivity to recognize a fingerprint of a finger which comes into contact therewith.

The plurality of sensing electrodes 120 sense a touch input externally applied thereto. For example, the plurality of sensing electrodes 120 are formed of one or more materials such as indium tin oxide (ITO), indium zinc oxide (IZO), zinc oxide (ZnO), carbon nano-tube (CNT) or graphene which may be transparent and have electrical conductivity, and may also be formed of a metal such as silver (Ag) or copper (Cu).

Here, sensing a touch input may refer to both sensing a position of a touch input and sensing a touch input itself. Thus, the plurality of sensing electrodes 120 may be attached to a display device such as a touch screen or a touch position of a touch input, and may detect a difference between a ridge and a valley of a fingerprint to recognize the fingerprint.

The driver 130 applies a driving signal to a plurality of sensing electrodes 120. For example, the driver 130 boosts a driving signal using a block such as an up-converter to have a higher voltage and apply the boosted driving signal to the plurality of sensing electrodes 120.

The sensor 140 senses a touch input from the plurality of sensing electrodes 120. For example, the sensor 140 receives a driving signal applied from the driver 130 through the plurality of sensing electrodes 120. Characteristics of a driving signal received by the sensor 140 may be changed as a touch input is applied to the plurality of sensing electrodes 120. That is, the sensor 140 senses the applied touch input upon sensing a change in the characteristics of the driving signal.

The sensor 140 is actuated to operate with a frequency higher than that of the driving signal. An operating frequency of the sensor 140 refers to a repeated period of a change in a state thereof. For example, when the sensor 140 includes a switching element, the operating frequency of the sensor 140 may be an ON/OFF frequency of the switching element.

During an operation of the sensor 140, noise corresponding to the operating frequency may be introduced. In general, noise caused by the plurality of sensing electrodes 120 is mostly distributed in a low frequency band in terms of a surrounding environment, contact characteristics, and structural characteristics. Also, when noise is interpreted as a specific signal, a magnitude of harmonics of noise may be significantly smaller than that of a fundamental wave.

Thus, as the operating frequency of the sensor 140 is higher, noise of an operating frequency introduced to the sensor 140 may be reduced. Thus, a signal-to-noise ratio (SNR) of the sensor 140 may be improved.

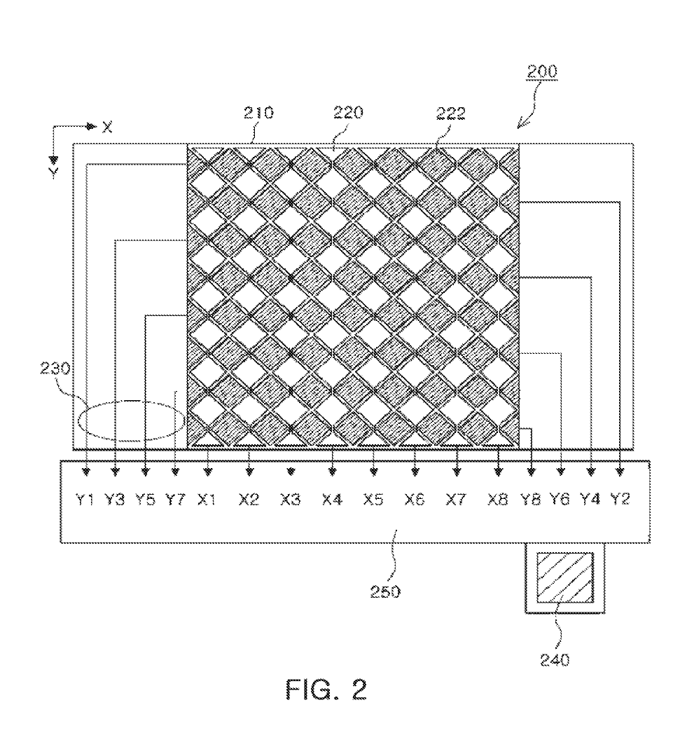

FIG. 2 is a view illustrating a structure of a plurality of sensing electrodes of FIG. 1.

Referring to FIG. 2, a touch input sensing device 200 according to the present embodiment includes a base substrate 210 formed of a transparent material, sensing electrodes 220 formed on the base substrate 210, wiring patterns 230 connected to the sensing electrodes 220, and a controller 240 electrically connected to the sensing electrodes 220 through the wiring patterns 230. As illustrated in FIG. 2, a circuit board 250 with the controller 240 mounted thereon or connected thereto is attached to a lower end of the base substrate 210 through anisotropic conductive film (ACF) bonding, or the like, and a bonding pad extending from the wiring patterns 230 is provided at a lower end of the base substrate 210 to allow each sensing channel terminal of the controller 240 to be electrically connected to the sensing electrodes 220 through the wiring patterns 230.

The sensing electrodes 220 may be formed of a transparent conductive material such as ITO, ZnO, IZO, or CNT, as described above, and have a predetermined pattern to allow the controller 240 to determine a touch input on the basis of a sensing signal generated by the sensing electrodes 220. The sensing electrodes 220 illustrated in FIG. 2 have a lozenge or diamond-shaped pattern, and unit electrodes 222 having the lozenge or diamond-shaped pattern are connected in a horizontal or vertical direction to form a single sensing electrode 220. Hereinafter, for the purposes of description, the sensing electrode 220 extending in the horizontal direction is referred to as a first electrode, and the sensing electrode 220 extending in the vertical direction will be referred to as a second electrode.

The first electrode and the second electrode have a shape in which the unit electrodes 222 having the lozenge or diamond-shaped pattern extend in the horizontal or vertical direction. The first electrode and the second electrode may be disposed on different layers or on the same layer. Spaces between the first electrodes are filled with the second electrodes, and in a case in which both the first electrode and the second electrode are disposed on the same layer, a bridge structure in which a predetermined insulating material is disposed at the intersection of the first electrode and the second electrode in order to electrically separate the two electrodes may be applied.

As illustrated in FIG. 2, the first electrodes and the second electrodes are connected to separate wiring patterns. That is, as illustrated in FIG. 2, in a case in which eight first electrodes and eight second electrodes are included in the touch input sensing device 200, a total of 16 wiring patterns 230 are provided in a bezel region of the base substrate 210, and the controller 240 may include at least sixteen sensing channels to be connected to the wiring patterns 230 separately.

The controller 240 is electrically connected to the sensing electrodes 220 through the sensing channels and the wiring patterns 230, and may include a driverapplying a driving signal to the sensing electrodes 230 and a sensor obtaining a sensing signal generated by the sensing electrodes 220. The sensing signal may be a change in self-capacitance generated between a contact object and the first electrode and the contact object and the second electrode or may be an electrical signal in which mutual-capacitance generated between the first electrode and the second electrode is changed by the contact object.

A driverfor applying a driving signal to at least one of the first electrode and the second electrode in a case in which a change in mutual capacitance is sensed may be included in the controller 240.

For example, the controller 240 measures a change in capacitance generated by the sensing electrode 220, in the form of a voltage. A change in capacitance measured as a magnitude of a voltage is converted into a digital signal by an analog-to-digital converter (ADC) or a time-to-digital converter (TDC), and the controller 240 determines coordinates of a touch input, a multi-touch, a gesture, or a fingerprint using the converted digital signal.

Also, the controller 240 may include a differential integrator for calculating a difference between sensing signals obtained from the sensing channels connected to neighboring sensing electrodes 220. The difference between the sensing signals calculated by the differential integrator may be used for a main controller of the controller 240 to determine a touch input. The differential integrator for calculating a difference between sensing signals obtained from the neighboring sensing electrodes 220 may be included in at least one of an analog circuit and a digital circuit of the controller 240.

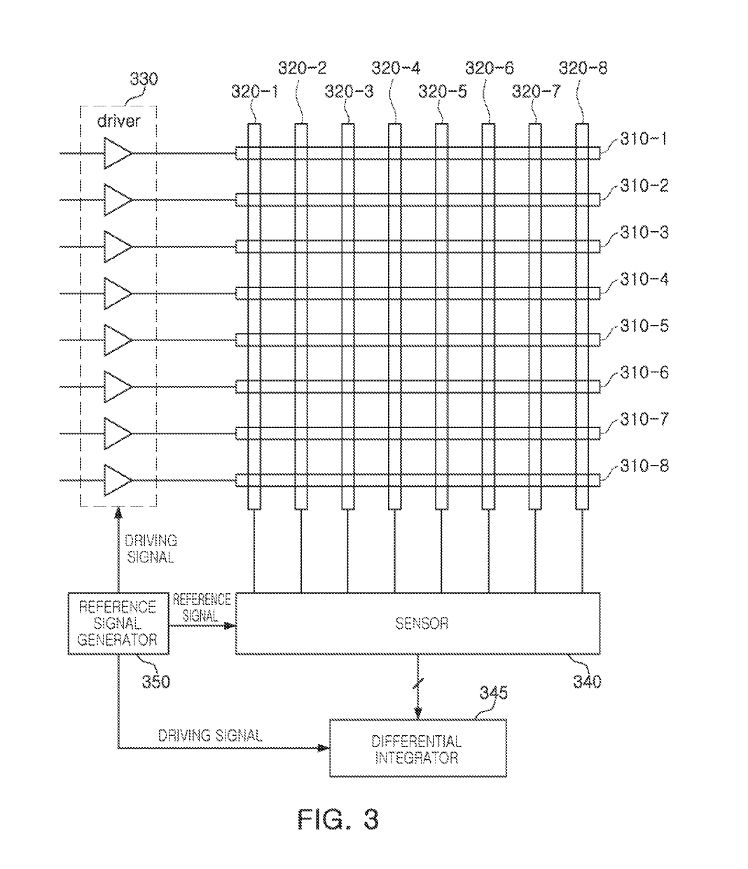

FIG. 3 is a view specifically illustrating a touch input sensing device according to an embodiment.

Referring to FIG. 3, drivers 330 are respectively connected to the first electrodes 310-1 to 310-8 extending in a horizontal direction, and the sensor 340 is connected to each of the second electrodes 320-1 to 320-8 extending in a vertical direction. In other configurations, these connections may be reversed. That is, in FIG. 3, a touch input sensing device 300 sensing mutual capacitance is assumed, but, as described above, the touch input sensing device according to an embodiment may also sense self-capacitance.

For example, the sensor 340 includes a charge pump circuit for measuring capacitance and is connected to a differential integrator 345 outputting a voltage having a level corresponding to a difference between sensing signals obtained from the sensing electrodes.

Also, an analog-to-digital converter (ADC) converting capacitance (which is generally measured as a magnitude of a voltage) measured as an analog value into a digital signal form may be connected to the differential integrator 345.

A reference signal generator 350 applying a driving signal to the driver 330 and a reference signal to the sensor 340 is connected to the driver 330 and the sensor 340. The reference signal generator 350 collectively generates the driving signal and the reference signal to thereby cause a time difference between a point in time at which the driving signal rises and a point in time at which the reference signal rises within a predetermined range.

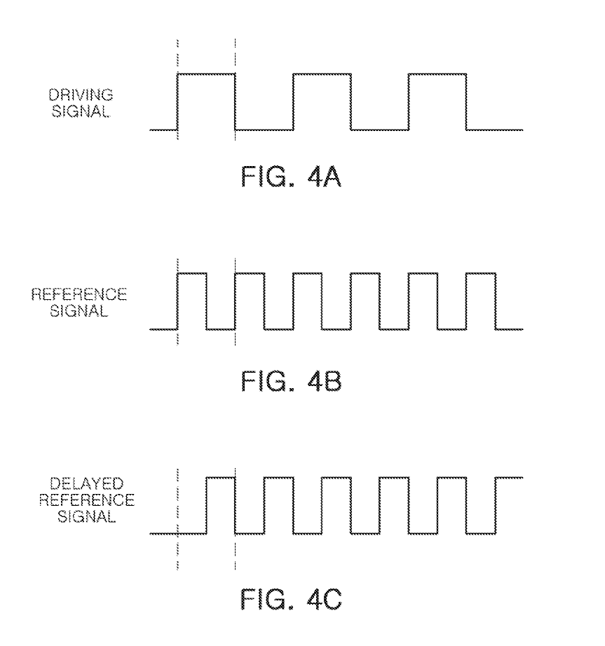

FIG. 4A is a view illustrating example waveforms of a first clock signal applied to the driver of FIG. 3.

FIG. 4B is a view illustrating example waveforms of a second clock signal applied to the sensor of FIG. 3.

FIG. 4C illustrates precedence or delay of the second clock signal.

For example, a reference signal generator 350 included in the touch input sensing device according to an embodiment generates the first clock signal as a driving signal and the second clock signal as a reference signal. A frequency of the second clock signal is set to be higher, for example, as a multiple of 2 relative to the first clock signal. Thus, a quasi-differential effect may be generated in the sensing circuit, and sensitivity of a touch input of the touch input sensing device may be enhanced.

Also, as illustrated in FIG. 4A and FIG. 4C, the reference signal generator causes a rising point of the second clock signal to be different from a rising point of the first clock signal. That is, one or the other, or both of the first clock signal and the second clock signal may adaptively adjusted to precede the other or may be delayed, one relative to the other.

As the frequency of the second clock signal is increased, the driving signal applied to the sensor through the sensing electrodesis distorted by an R-C delay time of the sensing circuit. The distortion occurs as the driving signal is applied to the sensor through the sensing electrodes before the second clock signal (which is input to the sensor) is settled. Thus, when the second clock signal precedes or is delayed compared with the first clock signal, the driving signal is applied to the sensor through the sensing electrodes after the second clock signal is settled. Thus, distortion of the sensor may be reduced.

In an embodiment, a delay time of the second clock signal is determined on the basis of capacitance of a capacitor included in the charge pump circuit included in the sensing circuit. Because capacitance of the capacitor and the R-C delay time are in proportion to each other, the delay time of the second clock signal may be adjusted to correspond to the R-C delay time.

If the frequency of the second clock signal is, for example, two-fold higher than that of the first clock signal, the reference signal generator may cause a point in time at which a level of the second clock signal starts to fall to match a point in time at which a level of the first clock signal starts to rise or fall.

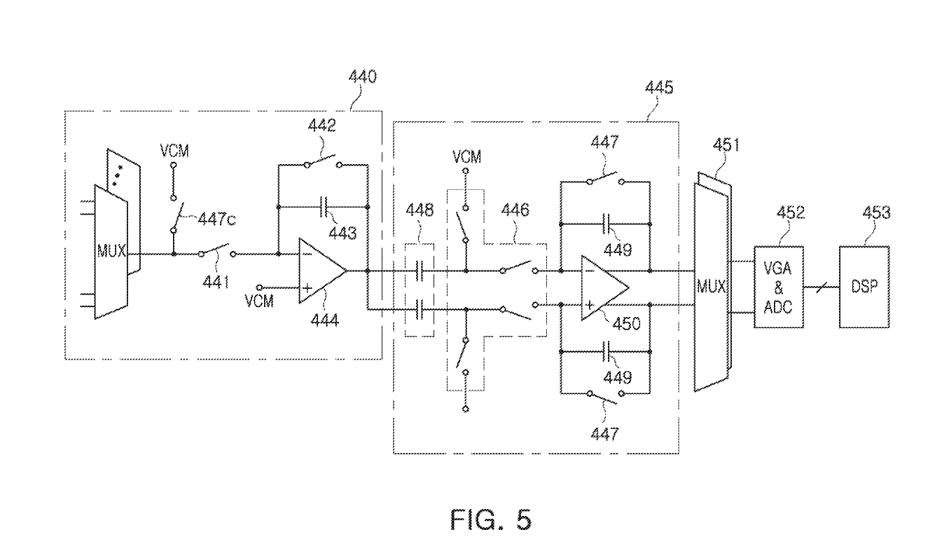

FIG. 5 is a circuit diagram specifically illustrating a sensor and a differential integrator of FIG. 3.

Referring to FIG. 5, a sensor 440 includes a first switch 441 connected to a plurality of sensing electrodes and configured to be turned on or off on the basis of a reference signal, a second switch 442 connected to the first switch 441 and configured to be turned on or off on the basis of the reference signal, a first capacitor 443 having one end connected to the first switch 441, and connected to the second switch 442 in parallel, and a first operational amplifier 444 having an input terminal connected to the first switch 441 and connected to the second switch 442 and the first capacitor 443 in parallel.

The sensor 440 performs an integration operation according to switching operations of the first switch 441 and the second switch 442. For example, the second switch 442 is in an OFF state when the first switch 441 is in an ON state, and in an ON state when the first switch 441 is in an OFF state.

By performing the integration operation, the sensor 440 converts a change in capacitance generated in the plurality of sensing electrodes into a corresponding voltage and amplifies the converted voltage.

Here, a quasi-differential effect may be generated in the sensor 440, and a corresponding output voltage of the sensor 440 is expressed by the following Equation 1. Here, Vin denotes a voltage of a driving signal, Cm denotes mutual capacitance between the first electrode and the second electrode of the plurality of sensing electrodes, and CF1 denotes capacitance of the first capacitor 443.

Vbo=(Vin*Cm/CF1)*2 (Equation 1)

Referring to FIG. 5, a touch input sensing device according to an embodiment further includes a differential integrator 445 connected to an output terminal of the sensor 440 and differentially integrating a single output from the sensor 440.

For example, the differential integrator 445 includes a plurality of second capacitors 448 differentially connected to the output terminal of the sensor 440, a plurality of third switches 446 connected to the plurality of second capacitors 448 and configured to be turned on or off on the basis of a driving signal, a plurality of fourth switches 447 connected to the plurality of third switches 446 and configured to be turned on or off on the basis of a driving signal, a plurality of third capacitors 449 having one end connected to the plurality of third switches 446 and connected to the plurality of fourth switches 447 in parallel, and a second operational amplifier 450 having an input terminal connected to the plurality of third switches 446 and connected to the plurality of fourth switches 447 and the plurality of third capacitors 449 in parallel.

The differential integrator 445 performs an integration operation according to switching operations of the plurality of third switches 446 and the plurality of fourth switches 447. By first performing a pre-integration operation on the basis of a reference signal, the sensor 440 serves as a buffer with respect to the differential integrator 445.

An output voltage from the differential integrator 445 is expressed by the following Equation 2. Here, Vbo denotes an input voltage of the differential integrator 445, CN denotes capacitance of the plurality of second capacitors 448, CF2 denotes capacitance of the third capacitor 449, Vcm denotes a DC bias of the differential integrator 445, and # denotes the number of integrations. The number of integrations of the differential integrator 445 illustrated in FIG. 5 is 2.

Vo_p(Vo_n)=Vbo*(CN/CF2)*#+Vcm (Equation 2)

The touch input sensing device according to an embodiment includes a multiplexer 451 connected to an output terminal of the differential integrator 445, an analog signal processing circuit 452 connected to the multiplexer 451 and performing amplifying, filtering, and converting operations on an analog signal, and a digital signal processing circuit 453 connected to the analog signal processing circuit 452 and processing a digital signal.

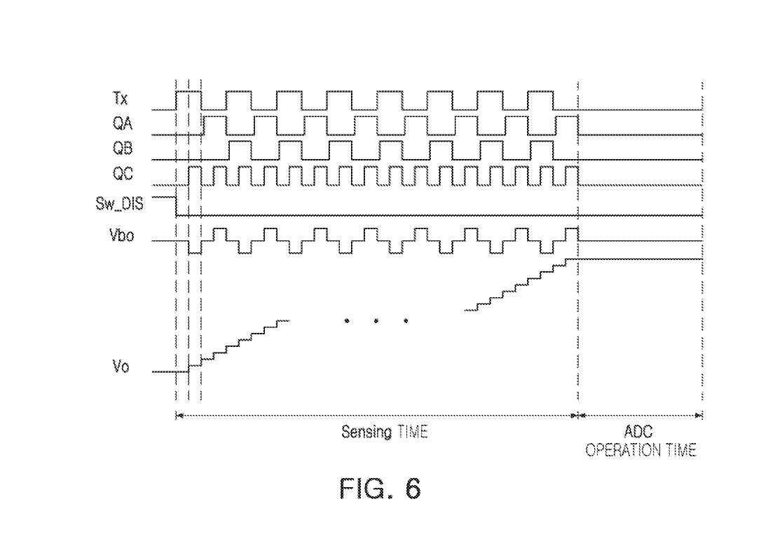

FIG. 6 is a view illustrating example waveforms at respective nodes of FIG. 5.

Referring to FIG. 6, Tx is a driving signal applied to the driving circuit, QA and QB are driving signals applied to the differential integrator. QC is a reference signal applied to the sensing circuit, and SW_DIS is a signal applied to the plurality of fourth switches, Vbo is an output voltage of the sensing circuit, and Vo is an output voltage of the differential integrator.

Here, the reference signal operates two-fold faster than the driving signal, and the differential integrator operates at the same frequency as the driving frequency. Also, it can be seen that the output voltage from the sensor has a quasi-differential effect.

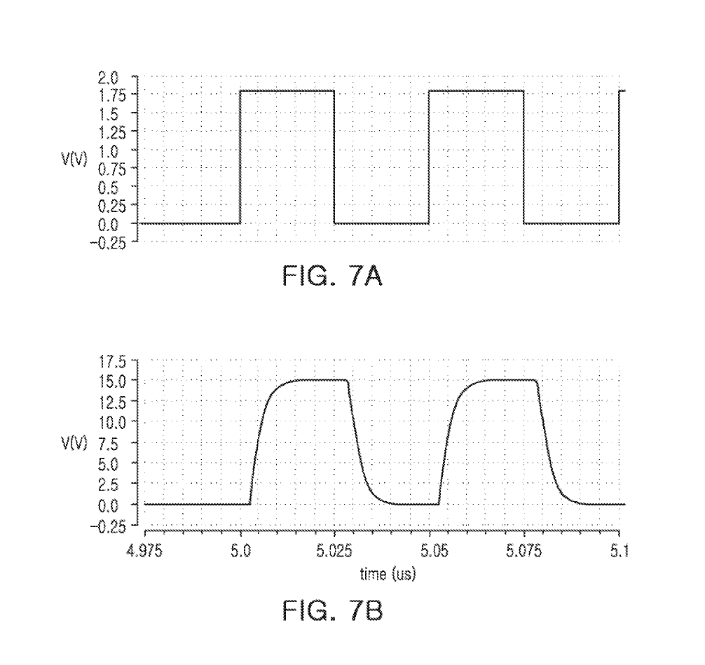

FIGS. 7A and 7B are graphs illustrating an input terminal waveform and an output terminal waveform of the driver of FIG. 3.

FIG. 7A illustrates the first clock signal applied to the driving circuit, and FIG. 7B illustrates a voltage output to a plurality of sensing electrodes by the driving circuit. For example, the driver boosts a voltage of 1.75V to a voltage of 15V. Here, the output voltage may be temporally distorted due to a delay time of the driving circuit. If the frequency of the first clock signal is 12.5 MHz, about 10 ns may be required to settle the output voltage.

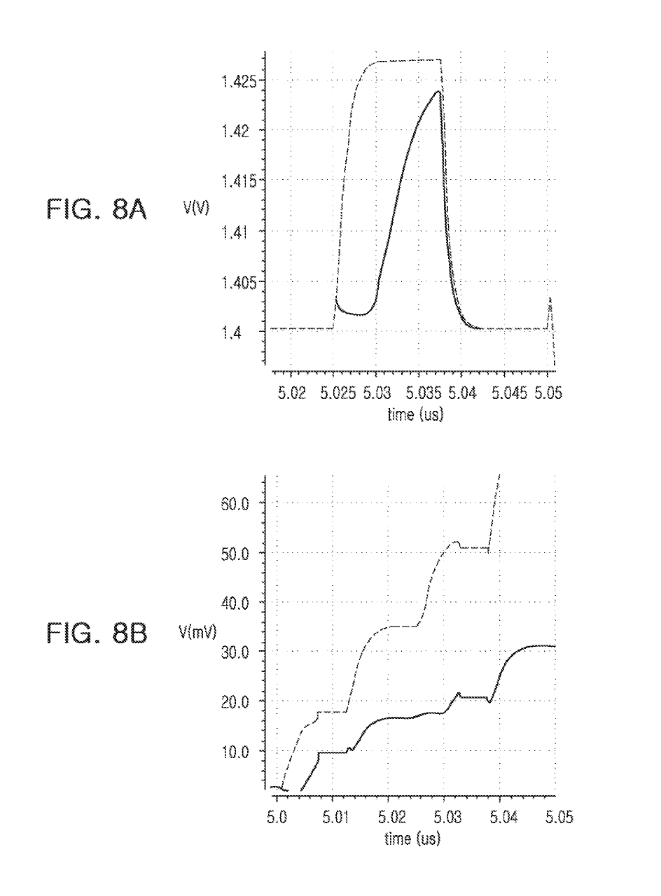

FIGS. 8A and 8B are graphs illustrating example waveforms of the sensor of FIG. 3 when a reference signal applied to the sensor is not delayed.

Referring to FIG. 8A, the dotted line represents an ideal output of the sensing circuit, and the solid line represents an actual output of the sensing circuit. Referring to FIG. 8B, the dotted line represents an ideal output of the differential integrator, and the solid line represents an actual output of the differential integrator. Herein, “ideal” merely refers to a conceptual or abstract operation of an electronic component which does not take into account certain inefficiencies, parasitics, or actual operational characteristics of a physically embodied electronic component.

It can be seen that it takes about 15 ns of delay for the sensor to be settled due to an RC delay time of the sensing circuit. If the frequency of the second clock signal is 25 MHz, the delay of about 15 ns refers to a phase delay of about 67.5 degrees. Thus, a voltage swell of the differential integrator receiving the distorted signal may also be distorted.

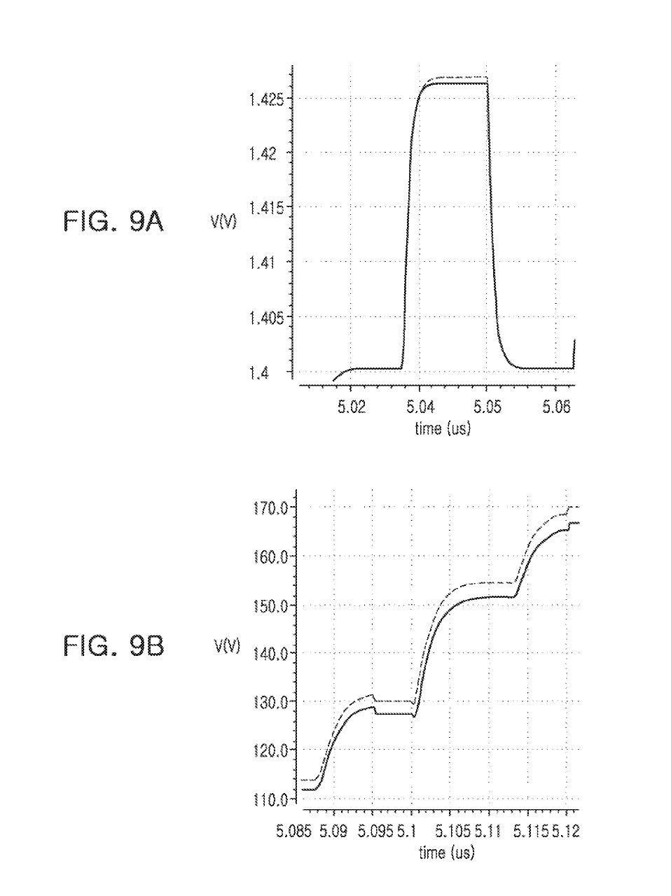

FIGS. 9A and 9B are graphs illustrating example waveforms of the sensor of FIG. 3 when a reference signal applied to the sensor is delayed.

Referring to FIG. 9A, the dotted line represents an ideal output of the sensing circuit, and the solid line represents an actual output of the sensing circuit. Referring to FIG. 9B, the dotted line represents an ideal output of the differential integrator, and the solid line represents an actual output of the differential integrator.

It is assumed that the reference signal is delayed by 90 degrees with respect to the driving signal. While the reference signal is delayed, the sensor may operate in a virtual ground state, whereby temporal degree of freedom may be enhanced and a time required for settling the sensor may be secured.

Thus, the time required for settling the sensor may be shortened and output distortion of the sensor and the differential integrator may also be reduced.

As set forth above, in the touch input sensing device according to embodiments, sensitivity of touch input sensing may be enhanced by reducing an influence of noise generated in the process of sensing a touch input, and distortion of touch input sensing may be reduced by reducing an influence of delay occurring in the process of sensing a touch input.

The apparatuses, units, modules, devices, and other components (e.g., the sensors 140, drivers 130, differential integrator 345, signal generator 350, DSP 453, etc.) illustrated in FIGS. 1-3 and 5 that perform the operations described herein with respect to FIGS. 4A-C and 6-9B are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 4A-C and 6-9B. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in 4A-C and 6-9B that perform the operations described herein are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

As a non-exhaustive example only, an electronic device as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device adapted for touch input. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A touch input sensing device comprising:
a sensing electrode;
a driver configured to apply a driving signal to the sensing electrode; and
a sensor configured to sense a touch input from the sensing electrode, and to operate at a frequency higher than that of the driving signal.

2. The touch input sensing device of claim 1, further comprising a reference signal generator configured to:
apply a reference signal having a frequency higher than that of the driving signal to the sensing circuit, and,
synchronize the driving signal and the reference signal such that a level of the reference signal is increased from a predetermined level at a point in time different from a point in time at which a level of the driving signal is increased from a predetermined level.

3. The touch input sensing device of claim 2, wherein the reference signal generator is further configured to generate:
the driving signal having a square wave, and
the reference signal having a square wave and a frequency about two-fold higher than that of the driving signal.

4. The touch input sensing device of claim 2, wherein the reference signal generator is further configured to generate a reference signal having a level falling at a point in time when the level of the driving signal rises or falls.

5. The touch input sensing device of claim 2, wherein the sensor includes:
a first switch connected to the plurality of sensing electrodes and configured to be turned on or off based on the reference signal;
a second switch connected to the first switch and configured to be turned on or off based on the reference signal;
a first capacitor having one end connected to the first switch, and connected to the second switch in parallel; and
a first operational amplifier having an input terminal connected to the first switch, the second switch, and the first capacitor, and an output terminal connected to the second switch and the first capacitor.

6. The touch input sensing device of claim 5 wherein the reference signal generator is further configured to determine a time difference between a point in time at which the level of the driving signal rises from a predetermined level and a point in time at which the level of the reference signal rises from a predetermined level, on the basis of capacitance of the first capacitor.

7. The touch input sensing device of claim 1, further comprising a differential integrator connected to the sensing circuit, the differential integrator configured to:
integrate an output signal from the sensing circuit, and convert the output signal to differential signal, and,
receive the driving signal and operate at a frequency of the driving signal.

8. The touch input sensing device of claim 1, wherein the sensing electrode includes:
a first electrode connected to the driver and configured to receive the driving signal; and
a second electrode disposed to intersect with the first electrode, connected to the sensor, and configured to provide a variation in capacitance according to a touch input to the sensing circuit,
wherein the sensing electrodes are configured to sense a difference in height between a ridge and a valley of a fingerprint of a contact finger and/or an interval between the ridge and the valley.

9. A touch input sensing device comprising:
a sensing electrode;
a driver configured to activate the sensing electrode;
a sensor configured to sense a touch input from the sensing electrode; and
a reference signal generator configured to apply a first clock signal to the driver and apply a second clock signal to the sensor,
wherein the reference signal generator is configured to adaptively stagger the first and second clock signals to prevent a rising point of the second clock signal from matching a rising point of the first clock signal.

10. The touch input sensing device of claim 9, wherein the reference signal generator is configured to set a frequency of the second clock signal to be higher than that of the first clock signal by a multiple of about 2.

11. The touch input sensing device of claim 9, wherein the reference signal generator is configured to delay a phase of the second clock signal such that a falling point of the second clock signal matches a rising point of the first clock signal.

12. The touch input sensing device of claim 9, wherein the sensor includes:
a first switch connected to the sensing electrode and configured to be turned on or off on the basis of the second clock signal;
a second switch connected to the first switch and configured to be turned on or off on the basis of the second clock signal;
a first capacitor having one end connected to the first switch, and connected to the second switch in parallel; and
a first operational amplifier having an input terminal connected to the first switch, and connected to the second switch and the first capacitor in parallel.

13. The touch input sensing device of claim 12, wherein the reference signal generator is configured to determine a time difference between a point in time at which the first clock signal rises and a point in time at which the second clock signal rises, on the basis of capacitance of the first capacitor.

14. The touch input sensing device of claim 9, further comprising a differential integrator connected to the sensing circuit, the differential integrator configured to:
integrate a single output signal from the sensing circuit,
convert the single output signal to a differential signal, and,
receive the first clock signal and operate at a frequency of the driving signal.

15. The touch input sensing device of claim 9, wherein the sensing electrode comprises:
a first electrode connected to the driver, the first electrode configured to receive the first clock signal; and
a second electrode disposed to intersect with the first electrode, the second electrode configured to connect to the sensor to provide a variation in capacitance according to a touch input to the sensing circuit,
wherein the sensing electrodes are configured to sense a difference in height between at least one of a ridge and a valley of a fingerprint of a contact finger or an interval between the ridge and the valley.

16. A touch input device comprising:
a plurality of sensing electrodes;
a sensor coupled to the plurality of sensing electrodes;
a signal generator configured to:
generate and apply a driving signal to the plurality of sensing electrodes; and,
generate and apply a reference signal to the sensor, wherein one of the reference signal and the driving signal are adaptively delayed one relative to the other; and,
a differential integrator coupled to the sensing electrodes, the differential integrator being configured to calculate a difference between sensed touch signals from neighboring sensing electrodes of the plurality of sensing electrodes.
